(19) United States
(12) Patent Application Publication
(10) Pub. No.: US 2011/0298235 A1
(43) Pub. Date: Dec. 8, 2011

(54) LIFTING DEVICE FOR LIFTING A CURB STONE

(76) Inventor: Kewen Paick, Aarslev (DK)

(21) Appl. No.: 13/148,016

(22) PCT Filed: Feb. 2, 2010
(86) PCT No.: PCT/DK2010/050030

§ 371 Date: Aug. 22, 2011

(30) Foreign Application Priority Data
Feb. 12, 2009 (DK) PA 2009 00202

(51) Int. Cl. B66C 1/44; E01C 19/52

(52) U.S. Cl. 294/207

(57) ABSTRACT

There is provided a lifting device for lifting a curb stone. The device comprises a frame (4) for attachment to a vehicle or other platform equipped with a hydraulic system. In the device a gripping portion (1) is provided and forms part of the frame. The gripping portion encloses two telescopic arms (1a, 1b) with opposite gripping jaws (2a, 2b) for clamping the ends of the curb stone. The arms are actuated by hydraulic cylinders (3a, 3b) being connected to an external hydraulic system.

### FIELD OF THE INVENTION

The present invention relates to a lifting device, and in particular to a lifting device to aid in lifting an elongate block of material, such as a curb stone or the like.

### BACKGROUND OF THE INVENTION

This invention relates to a lifting device and in particular to a device adapted for lifting curbing sections, such as those formed from concrete or cement and utilized adjacent roadways and the like. Such curbing sections are generally lifted into place by a three-man team including two men at the curb section itself and another man operating the lifting device, such as a crane, backhoe, or the like, from which a cable is attached to the curbing section via loops surrounding a cross-sectional portion thereof.

A number of devices to theoretically improve the lifting of curb sections or similarly shaped heavy articles have been devised and are set forth in the following patents: U.S. Pat. No. 1,888,083; U.S. Pat. No. 2,676,838; U.S. Pat. No. 2,851,300, and DE 1,297,313. These patents illustrate devices that are believed to be operational and capable of alleviating one or more of the various problems normally associated with lifting of such heavy sections, but they still do not completely resolve the particular problems normally associated with the lifting of curb sections in a road constructional environment.

The desirable features of a device for lifting and setting curb sections include a structure which substantially directly overlies the top of the curb section such that it can be easily manipulated in place by one person. A further desirable feature of a device of this type is that it operates so as to grasp the curb section without either completely encircling or engaging at least a portion of the bottom curb surface. This feature is desirable as the bottom surface of curbing is not always readily accessible (as when repositioning previously positioned curbs) or when removal of the engaging device would be a problem.

Other known devices are relatively complex (such as that shown in, for example, U.S. Pat. No. 4,545,609) making it difficult to lay curbstones or slabs in end to end relationship (such as the devices shown in French Patent Specification 2611771 and British Patent Specification 645790). In the devices referred to lifting force on the block is applied via cable type actuators. This is inherently unsafe.

FR2706920A1 discloses a lifting device for lifting a curb stone. The device comprises plates provided with handles and a gripping portion which encloses two hydraulically actuated telescopic arms slidable in a single axis and in opposite direction within the gripping portion, said telescopic arms having opposite gripping jaws for clamping the ends of the curb stone. Meanwhile FR2706920A1 does not disclose a lifting device with a frame which is suitable for attachment to a vehicle and which is simple in construction and easy to manipulate.

Hence, there is a need for an improved device for lifting curb stones.

### SUMMARY OF THE INVENTION

An improved lifting device has now been devised in accordance with the present invention.

According to the invention there is provided a lifting device for lifting a curb stone, said device comprises:
a frame (4) for attachment to a vehicle or other platform equipped with a hydraulic (10) system, said frame being provided with handles (5) to be used by a worker for correct orientation of the lifting device carrying a curb stone,
a gripping portion (1) which encloses two telescopic arms (1a, 1b) slidable within the gripping portion (1) in a horizontal axis and actuated by hydraulic gripping cylinders (3a, 3b) connectable to the hydraulic system (10), said telescopic arms having opposite gripping jaws (2a, 2b) for clamping the ends of the curb stone, and
alignment means (6) for correct positioning of the curb stone within the device.

Preferably, the frame (4) of the lifting device of the present invention takes the form of a triangle, wherein the gripping portion constitutes the base of the triangle.

In a preferred embodiment the lifting device of the present invention has a frame composed of rods having a quadratic inner cross section, whereas the outer cross section of the telescopic arms sliding in the gripping portion is correspondingly quadratic so as to make a perfect fit there between. Alternatively, the frame of the lifting device is composed of rods having a circular inner cross section, whereas the telescopic arms have an essentially circular outer cross section.

In a further embodiment the gripping jaws are attached directly on the ends of the pistons of the gripping cylinders. In this embodiment no telescopic arms are present in the gripping portion, but the gripping cylinders are fixed onto the inner surface of the gripping portion.

In still another embodiment the gripping jaws are attached to the pistons through an elongate slit in the bottom wall of the gripping portion. In this embodiment the gripping range may be extended if the gripping cylinders are oriented towards each other, yet in a way that allows the pistons of the cylinders to pass by each other.

In another preferred embodiment of the present invention additional gripping means may be releasably attached to the gripping jaws to allow for the lifting of smaller curb stones or other objects.

### BRIEF DESCRIPTION OF THE DRAWING

FIG. 1 is a view of a preferred embodiment of a lifting device according to the present invention.

### DETAILED DESCRIPTION OF THE INVENTION

The invention will now be further described in a specific embodiment by way of example only.

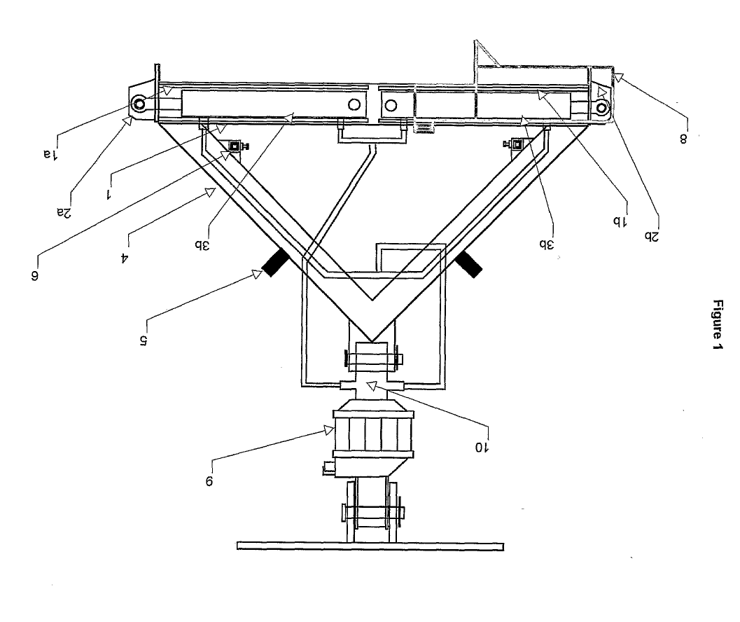

Referring to FIG. 1, there is shown a device comprising a welded metal frame (4) for lifting a curb stone. The frame comprises a pair of limbs attached to the gripping portion (1) which encloses hydraulic cylinders connected with the two opposite gripping jaws (2a, 2b) for clamping the ends of the curb stone. The frame is provided with means for connecting the frame to a vehicle or other platform equipped with a hydraulic system (10). Moreover the frame is provided with handles (5) which ensures that a worker may correctly position the lifting device when the curb stone is to be set. The gripping jaws (2a, 2b) are actuated by the hydraulic gripping cylinders (3a, 3b) within a horizontal axis. The hydraulic gripping cylinders (3a, 3b) are connectable to the hydraulic system (10) that provides the force needed to hold the curb stone in place during operation. Moreover, the frame is provided with alignment means (6) ensuring correct positioning of the curb stone within the device. In order to ensure appropriate rotation of the lifting device a rotating unit (9) may be employed.

The gripping jaws are designed in such a manner that they do not grip below the curb stone but press, by lateral pressure, onto the ends of the curb stone. The required clamping force generated by the hydraulic gripping cylinders and exerted by the gripping jaws on the ends of the curb stone depends on the weight of the curb stone; in general this force must be at least 1.5 times the gravitational force of the curb stone.

When the curb stone is to be set down the gripping jaws are moved away from one another by reducing the pressure in the hydraulic gripping cylinders. On setting the curb stone the gripping jaws will be located in the joints between curb stones already set and those newly put down. Accordingly, it becomes necessary for the jaws to be pulled up perpendicular so that on being lifted they will not jam within the joint and cause dislocations in the curb.

It must be made possible to have the curb stone exactly along the existing curb. For this purpose, the lifting device of the present invention must allow for rotating and swinging in all directions. Furthermore, the suspended curb stone must always be hanging horizontally, independent of the respective position of the vehicle or platform onto which the lifting device is attached. Thus, the lifting device is linked pivotable via a pin to the vehicle or platform. A pin allows pivoting in a direction offset by 90°. To allow rotation around a vertical center axis, a convex horizontal disc rests in a matching socket. The disc is rigidly connected to a pin which has an eye at its other end.

Preferably the lifting device is attached to a vehicle or platform through an outrigger arm, which also provides for appropriate connections to the hydraulic system required for operating the hydraulic cylinders of the lifting device. In order to raise the lifting device to such a height that a curb stone can be lifted from a stack up to 1.20 meters high, the outrigger arm is elevated by a hydraulic cylinder. The outrigger arm will pivot around a bearing.

In an alternative embodiment the lifting device may be configured so that the gripping jaws are directly attached to the pistons of the hydraulic gripping cylinders, which presupposes that the gripping cylinders are kept in place within the gripping portion. In this embodiment the pistons of the gripping cylinders are provided with gripping jaws in the ends.

In still another embodiment the gripping jaws are fixed to the ends of the pistons through a slit made in the lower wall of the gripping portion. In this embodiment the length of gripping portion is longer than the curbstone.

Also the present invention provides an embodiment, wherein additional gripping means may be releasably attached to the gripping jaws to allow for the lifting of smaller curb stones or other objects. This may be achieved by fixing an overlaid gripping part to either directly to the ends of the gripping pistons or by fixing the part (8) to the gripping jaws.

While this invention has been described with reference to an illustrative embodiment, this description is not intended to be construed in a limiting sense. Various modifications of the illustrative embodiment as well as other embodiments of the invention will be apparent to persons skilled in the art upon reference to the description.

1. A lifting device for lifting a curb stone, which device comprises:
a frame for attachment to a vehicle or other platform equipped with a hydraulic system, said frame being provided with handles for correct positioning of the lifting device loaded with the curb, characterised in that the device includes:
a gripping portion being part of the frame and which encloses two telescopic arms slidable in a single axis and in opposite directions within the gripping portion and actuated by hydraulic cylinders connectable to the hydraulic system, said telescopic arms having opposite gripping jaws for clamping the ends of the curb stone, and
alignment means for correct positioning of the curb stone within the device.

2. Lifting device for lifting a curb stone according to claim 1, wherein the frame takes the form of a triangle, wherein the gripping portion constitutes the base of the triangle.

3. Lifting device for lifting a curb stone according to claim 1, wherein the frame is composed of rods having a quadratic inner cross section.

4. Lifting device for lifting a curb stone according to claim 1, wherein the frame is composed of rods having a circular inner cross section.

5. Lifting device for lifting a curb stone according to claim 1, wherein the frame is provided with a control panel for operating the lifting device.

6. Lifting device for lifting a curb stone according to claim 1, wherein the gripping portion is dimensioned with a length and breadth corresponding to the curb stone to be lifted.

7. Lifting device for lifting a curb stone according to claim 6, wherein the length of the gripping portion is 90%, especially 95%, of the length of the curb stone to be lifted.

8. Lifting device for lifting a curb stone according to claim 1, wherein the frame is made from stainless steel.
